(19) United States
(12) Patent Application Publication
(10) Pub. No.: US 2025/0333559 A1
(43) Pub. Date: Oct. 30, 2025

(54) INTRINSICALLY REPROCESSABLE DOUBLE-NETWORK ELASTOMERS

(71) Applicant: UNIVERSITY OF VIRGINIA PATENT FOUNDATION, Charlotesville, VA (US)

(72) Inventors: Shifeng NIAN, Charlottesville, VA (US); Liheng CAI, Charlottesville, VA (US)

(21) Appl. No.: 18/868,496

(22) PCT Filed: May 25, 2023
(86) PCT No.: PCT/US2023/023566

§ 371 Date: Nov. 22, 2024

Related U.S. Application Data
(60) Provisional application No. 63/345,749, filed on May 25, 2022.

(51) Int. Cl. C08F 293/00; B29C 64/118; B29K 33/00; B29K 105/00; B33Y 10/00; C08J 11/06; C09D 153/00

(52) U.S. Cl. CPC C08F 293/005; C08J 11/06; C09D 153/00; B29C 64/118; B29K 2033/08; B29K 2105/0085; B33Y 10/00; C08F 2438/01; C08J 2353/00

(57) ABSTRACT

According to some embodiments, a linear-reversible-linear (LRL) copolymer may comprise an A (BC) A triblock copolymer. The A (BC) A triblock copolymer may comprise an A block and a BC block. The A block may a linear polymer and the BC block may comprises a copolymer with the ability to form reversible bonds. Further embodiments include methods of making and methods of using the LRL copolymer.

### CROSS-REFERENCE TO RELATED APPLICATIONS

This application claims priority to U.S. Provisional Application Ser. No. 63/345,749, filed on May 25, 2022, the content of which is incorporated by reference herein, including the appendix thereof.

### STATEMENT OF GOVERNMENT INTEREST

This invention was made with government support under Grant No. 1944625 awarded by the National Science Foundation. The government has certain rights in the invention.

### TECHNICAL FIELD

This disclosure relates to polymers, and more particularly to reprocessable polymers.

### BACKGROUND

Reversible polymer networks are crosslinked by physical rather than covalent bonds; examples include hydrogen bonds, metal-ligand coordination, host-guest interactions, ionic interactions, electrostatic interactions, hydrophobic associations, or π-π stacking. Unlike commonly seen polymer networks such as rubber, reversible polymer networks can be reprocessed or revert to their original state after damage. As such, reversible polymer networks hold great promise as a new class of sustainable materials. While reversible associations are stronger than the van der Waals force, they are much weaker than covalent bonds. Consequently, reversible networks are often mechanically weak and have rather limited practical applications.

Introducing permanent, covalent crosslinks into a reversible network forms double-network polymers, which improves the mechanical properties of the polymer. The permanent crosslinks, however, prevent the polymers from being reprocessed or recycled.

Upon deformation, the reversible bonds break and reform to dissipate energy, whereas the covalent bonds maintain the material integrity. This concept has been extensively exploited to create tough double-network hydrogels. Nevertheless, hydrogels contain a large amount of water that can evaporate, whereas diverse applications often require polymers that are solvent-free, such that they do not leach molecules and change properties. It is challenging to apply the double-network concept to solvent-free polymer networks, largely because reversible crosslinks are often polar motifs, whereas covalent crosslinks are nonpolar motifs. These two types of bonds are intrinsically immiscible without co-solvents. Thus the permanent crosslinks may prevent the polymers from being reprocessed or recycled conveniently. Thus, reprocessable double-network elastomers, especially double-network elastomers which can be reprocessed with a single solvent are desired.

### BRIEF SUMMARY

Embodiments of the present disclosure meet this need by providing intrinsically reprocessable double-network elastomers. These intrinsically reprocessable double-network elastomers may be LRL copolymers comprising a linear block, a reversible middle block, and a linear block. The LRL copolymers self-assemble to form a double-network elastomer, with pair-wise reversible hydrogen bonds between the reversible middle blocks. The linear blocks may form nanoscale hard, glassy domains that act as crosslinks at room temperature but not at elevated temperature or in the presence of particular solvents. The addition of the reversible bonds may not only enhance energy dissipation but also may increase tensile strength. Moreover, exploiting more ordered microstructures afforded by block copolymer self-assembly may increase the tensile strength by >100 times, resulting in shear moduli and tensile toughness that are comparable to existing permanent double-network elastomers. The self-assembled elastomers may be thermally stable up to 180° C. yet 100% solvent-reprocessable. Further embodiments meet this need by providing methods of reprocessing and methods of making the intrinsically reprocessable double-network elastomers.

According to a first aspect, a linear-reversible-linear (LRL) copolymer may comprise an A (BC) A triblock copolymer, wherein: the A (BC) A triblock copolymer may comprise an A block and a BC block; the A block comprises a linear polymer; and the BC block comprises a copolymer with the ability to form reversible bonds.

According to a second aspect, in conjunction with the first aspect, B may be the residue of a spacer monomer, and C may be the residue of a sticky monomer.

According to a third aspect, in conjunction with aspects 1 or 2, each sticky monomer may comprise a single amide group.

According to a fourth aspect, in conjunction with any one of aspects 1-3, the triblock copolymer may have the structure A_{y}(B_{1-λ}C_{λ})ₓA_{y}.

According to a fifth aspect, in conjunction with any one of aspects 1-4, a volume fraction (ƒ) of the A block may be from 6% to 40%.

According to a sixth aspect, in conjunction with any one of aspects 1-5, subscript 2 (representing the fraction of reversible groups) may be at least about 0.05.

According to a seventh aspect, in conjunction with any one of aspects 1-6, the A blocks may have a glass transition temperature above 20° C.; and the BC block may have a glass transition temperature below 20° C.

According to an eighth aspect, in conjunction with aspects 4, subscript x (the degree of polymerization of the BC block) may be from 200 to 300.

According to a ninth aspect, in conjunction with any one of aspects 1-8, the LRL copolymer may have an absolute molecular weight of less than 46 kg/mol.

According to a tenth aspect, in conjunction with any one of aspects 1-9, A may be a residue of poly(benzyl methacrylate) (PBₙMA); B may be a residue of hexyl acrylate (HA); and C may be a residue of 5-acetamido-1-pentyl acrylate (AAPA).

According to an eleventh aspect, in conjunction with any one of aspects 1-10, the LRL copolymer may have a tensile strength of at least 1 MPa.

According to a twelfth aspect, in conjunction with any one of aspects 1-11, the LRL copolymer may have a network breaking strain of at least 1.2.

According to a thirteenth aspect, in conjunction with any one of aspects 1-12, the LRL copolymer may have a network tensile toughness of at least 1 MJ/m³.

According to a fourteenth aspect, in conjunction with any one of aspects 1-13, the triblock copolymer may have the structure A_{y}(B_{1-λ}C_{λ})A_{y}; A may be a residue of poly(benzyl methacrylate) (PBₙMA), B may be a residue of hexyl acrylate (HA), and C may be a residue of 5-acetamido-1-pentyl acrylate (AAPA); a volume fraction (ƒ) of the A block may be from 6% to 40%; a fraction of reversible groups (λ) may be from 0.05 to 1.0; the reversible middle block may comprise from 0.5 to 8 amide groups per Kuhn segment of the reversible middle block; the A blocks may have a glass transition temperature above 20° C.; and the BC block may have a glass transition temperature below 20° C.

According to a fifteenth aspect, in conjunction with any one of aspects 1-14, a method of recycling the LRL copolymer may comprise dissolving the LRL copolymer in a solvent; and evaporating the solvent.

According to a sixteenth aspect, in conjunction with aspects 15, a method of synthesizing a linear-reversible-linear (LRL) copolymer may comprise copolymerizing a sticky monomer and a spacer monomer to form a random copolymer; and copolymerizing the random copolymer with a small monomer to form the LRL copolymer.

According to a seventeenth aspect, in conjunction with aspects 16, copolymerizing the sticky monomer and the spacer monomer may comprise combining 2f-BiB, anisole, the sticky monomer, and the spacer monomer to produce a first random copolymer solution; combining the sticky monomer and the spacer monomer with a catalyst solution; introducing a reducing agent to the first random copolymer solution, thereby producing a second random copolymer solution; reacting the second random copolymer solution, thereby producing a crude random copolymer; and purifying the crude random copolymer to form the random copolymer.

According to an eighteenth aspect, in conjunction with any one of aspects 16-17, copolymerizing the random copolymer with the small monomer may comprise: combining a methacrylate compound, the random copolymer, and anisole; combining the methacrylate compound and the random copolymer with a catalyst solution, thereby producing a first LRL solution; reacting the first LRL solution to produce a crude LRL copolymer; and purifying the crude LRL copolymer, thereby producing the LRL copolymer.

According to a nineteenth aspect, in conjunction with any one of aspects 16-18, the method may further comprise synthesizing the sticky monomer by: combining an amino containing compound with an acetate; combining the amino containing compound and the acetate with acetic anhydride to form a first monomer solution; introducing an alcohol to the first solution to produce a second monomer solution; evaporating solvent from the second solution to produce a first acetamido compound; combining the acetamido compound with acrylic acid and a solvent to produce a third monomer solution; and evaporating solvent from the third solution to produce a crude sticky monomer; and purifying the crude sticky monomer to produce the sticky monomer.

According to a twentieth aspect, in conjunction with any one of aspects 1-19, a method of additive manufacturing may comprise 3-d printing an article using an LRL copolymer as the feedstock.

### BRIEF DESCRIPTION OF THE SEVERAL VIEWS OF THE DRAWINGS

The following detailed description of specific aspects of the present disclosure can be best understood when read in conjunction with the following figures, in which like structure is indicated with like reference numerals and in which:

FIG. 1 graphically depicts a proton nuclear magnetic resonance (¹H NMR) spectra of some embodiments of the reversible middle block copolymer of the present disclosure.

FIG. 2 graphically depicts a proton nuclear magnetic resonance (¹H NMR) spectra of some embodiments of the control triblock copolymer.

FIG. 3 graphically depicts a proton nuclear magnetic resonance (¹H NMR) spectra of some embodiments of the triblock copolymer of the present disclosure.

FIG. 4 graphically depicts the effect of λ on the storage moduli, shear moduli, and shear storage moduli of some embodiments of the triblock copolymer of the present disclosure.

FIG. 5 graphically depicts the dependence of tensile toughness on λ of some embodiments of the triblock copolymer of the present disclosure.

FIG. 6 graphically depicts the effect of ƒ on the storage moduli, shear moduli, and shear storage moduli of some embodiments of the triblock copolymer of the present disclosure.

FIG. 7 graphically depicts the dependence of tensile toughness on ƒ of some embodiments of the triblock copolymer of the present disclosure.

FIG. 8 graphically depicts the stress-strain curves of fresh and recycled triblock copolymer, in accordance with some embodiments of the present disclosure.

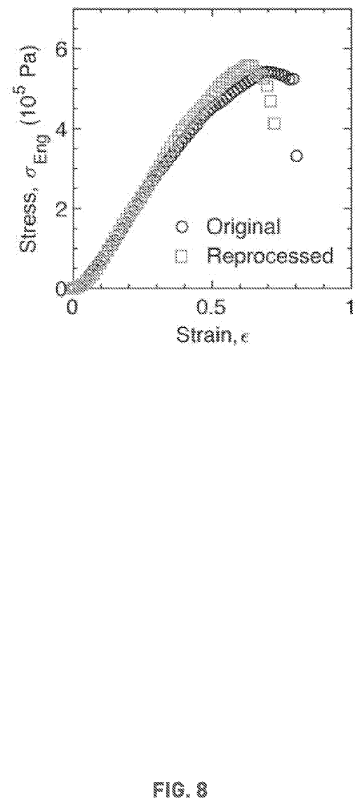

Reference will now be made in greater detail to various aspects of the present disclosure, some aspects of which are illustrated in the accompanying drawings.

### DETAILED DESCRIPTION

As mentioned above, polymers which can be reprocessed repeatedly and using only a single solvent are desired. Embodiments of the present disclosure meet this need by providing a linear-reversible-linear (LRL) copolymer where the LRL copolymer is an A (BC) A triblock copolymer; the A block may comprise a linear polymer; and the BC block may comprise a random copolymer with the ability to form reversible bonds. Further embodiments of the present disclosure meet this need by providing methods of making, methods of using, and methods of recycling the LRL copolymer.

Although exemplary embodiments are described in detail herein, other embodiments are contemplated. Accordingly, this disclosure is not limited in scope to the details of construction and arrangement of components described herein or illustrated in the drawings. The disclosure thus includes other embodiments and systems or methods that may be practiced or carried out in various ways.

Any of the components or modules referred to herein with regard to any of the embodiments may be integrally or separately formed with one another. Redundant functions or structures of the components or modules may be implemented or utilized. The various components may be communicated locally and/or remotely with any user/operator/customer/client or machine/system/computer/processor. The various components may be in communication via wireless and/or hardwire or other available communication means, systems and hardware. Various components and modules may be substituted with other modules or components that provide similar functions.

The systems, devices, and related components described herein may be configured to any of the various shapes along the entire continual geometric spectrum of manipulation of x, y and z planes to provide and meet the environmental, anatomical, and structural demands and operational requirements. Locations and alignments of the various components may vary as desired or required. Various sizes, dimensions, contours, rigidity, shapes, flexibility and materials of any of the components or portions of components in the various embodiments may be varied and utilized as desired or required. While some dimensions are provided on the aforementioned figures, the device may constitute various sizes, dimensions, contours, rigidity, shapes, flexibility and materials as it pertains to the components or portions of components of the systems and devices, and therefore may be varied and utilized as desired or required.

As used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

In describing embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4).

“Copolymer” refers to a polymeric compound prepared by polymerizing two or more types of monomers.

“Kuhn segments,” are sections of a polymer chain with Kuhn length (“b”). Each Kuhn segment can be thought of as if they are freely jointed with each other. Each segment in a freely jointed chain can randomly orient in any direction without the influence of any forces, independent of the directions taken by other segments. A polymer chain will have A connected segments, called Kuhn segments that can orient in any random direction.

The length of a fully stretched chain is L=Nb & for the Kuhn segment chain. In the simplest treatment, such a chain follows the random walk model, where each step taken in a random direction is independent of the directions taken in the previous steps, forming a random coil. The average end-to-end distance for a chain satisfying the random walk model is [symbol] R² [symbol] =Nb².

Since the space occupied by a segment in the polymer chain cannot be taken by another segment, a self-avoiding random walk model can also be used.

For an actual homopolymer chain (consists of the same repeat units) with bond length l and bond angle θ with a dihedral angle energy potential, the average end-to-end distance can be obtained as

$$〈 {R}^{2} 〉 = {nl}^{2} \frac{1 + cos ( θ )}{1 - cos ( θ )} \cdot \frac{1 + ( cos ( ϕ ) )}{1 + ( cos ( ϕ ) )} ,$$

where [symbol] cos(ϕ) [symbol] is the average cosine of the dihedral angle.

The fully stretched length L=nl cos(θ/2). By equating the two expressions for [symbol] R² [symbol] and the two expressions for L from the actual chain and the equivalent chain with Kuhn segments, the number of Kuhn segments N and the Kuhn segment length b can be obtained.

For a worm-like chain, Kuhn length equals two times the persistence length.

“Polymer” refers to a polymeric compound prepared by polymerizing monomers, whether of the same or a different type. The term polymer includes both homopolymers (polymers prepared from a single type of monomer) and copolymers, with the understanding that trace impurities may be incorporated into the polymer structure.

“Random copolymer” refers to a copolymer wherein the different monomer residues are arranged in a random order within the polymer chain.

“Sticky monomer” refers to monomers which comprise “stickers.”

“Stickers” refers to groups capable of forming reversible bonds with other compounds. The reversible bonds may comprise hydrogen bonds. The stickers may be amide groups.

“Spacer monomer” refers to monomers which lack stickers.

Embodiments of the present disclosure provide a linear-reversible-linear (LRL) copolymer. The LRL copolymer may be an A (BC) A triblock copolymer. The A block may comprise a linear polymer. The BC block may comprise a copolymer with the ability to form reversible bonds.

The BC block (also referred to herein as the “reversible middle block”) may comprise a copolymer with the ability to form reversible bonds. In embodiments, the BC block may be a random copolymer. In alternate embodiments, the BC block may be a structured block copolymer, such as an BCBC copolymer, a BBCCBBCC copolymer or any other copolymer organizational structure. The reversible bonds may be physical bonds rather than more permanent covalent bonds. These physical bonds may be hydrogen bonds, such as amide-amide hydrogen bonds. Without being limited by theory, it is believed that these reversible bonds may enhance energy dissipation and increase tensile strength. The incorporation of the reversible bonds may enable the creation of polymer networks which can be reprocessed or revert to their original state after damage.

The reversibility of the BC block may be provided by “stickers.” Stickers may refer to compounds capable of forming physical bonds, such as hydrogen bonds, within the polymer network. Stickers may refer to amide groups. Accordingly, the BC block may comprise amide groups.

C may be a residue of a sticky monomer. The sticky monomer may comprise one or more stickers. In embodiments, the stickers may comprise amide groups. The sticky monomer may comprise one or more amide groups, such as a single amide group. In embodiments, the sticky monomer may be a residue of 5-acetamido-1-pentyl acrylate (AAPA).

Further embodiments are envisioned where the BC block of the LRL copolymer only comprises sticky monomers and does not comprise spacer monomers. In such embodiments, B is also the residue of a sticky monomer, such as the same sticky monomer as C.

B may be a residue of a spacer monomer. The spacer monomer may be a monomer of approximately the same length as the sticky monomer, except that the spacer monomer may not include “stickers.” In embodiments, the spacer monomer may have approximately the same size and shape as the sticky monomer. Without being limited by theory, it is believed that when the sticky monomer and the spacer monomer have approximately the same size and shape, then the size of a Kuhn segment of the BC block will not change with the ratio of B to C. In embodiments, the spacer monomer may be a reside of hexyl acrylate (HA).

The reversible middle block may have a glass transition temperature (T_{g}) below the working temperature of the material, such that the reversible middle block does not form a glassy phase at rest. It is believed that the existence of the non-glassy phases created by the reversible middle block adds strength and toughness to the polymer network. In embodiments, the reversible middle block may have a glass transition temperature below 20° C., such as less than 10° C., less than 0° C., less than −10° C., less than −20° C., less than −30° C., less than −50° C., from −80° C. to 0° C., or any subset thereof. The glass transition temperature may refer to the glass transition temperature of the entangled polymer.

The BC block may have an absolute molecular weight (Mw) of from 20 kg/mol to 2000 kg/mol. In embodiments, the BC block may have an absolute molecular weight (Mw) of from 30 kg/mol to 2000 kg/mol, from 40 kg/mol to 2000 kg/mol, from 80 kg/mol to 2000 kg/mol, from 160 kg/mol to 2000 kg/mol, from 300 kg/mol to 2000 kg/mol, from 500 kg/mol to 2000 kg/mol, from 750 kg/mol to 2000 kg/mol, from 1000 kg/mol to 2000 kg/mol, from 30 kg/mol to 1500 kg/mol, from 30 kg/mol to 1000 kg/mol, from 30 kg/mol to 750 kg/mol, from 30 kg/mol to 500 kg/mol, from 30 kg/mol to 300 kg/mol, from 30 kg/mol to 150 kg/mol, from 30 kg/mol to 75 kg/mol, from 30 kg/mol to 50 kg/mol, from 30 kg/mol to 40 kg/mol, or any subset thereof.

The BC block may have a polydispersity index (PDI) of from 1.0 to 1.5. In embodiments, the BC block may have a PDI of from 1.0 to 1.4, from 1.0 to 1.3, from 1.1 to 1.5, from 1.2 to 1.5, from 1.1 to 1.4, from 1.2 to 1.3, or any subset thereof. The PDI may be determined by gel permeation chromatography (GPC).

The triblock copolymer may have the structure A_{y}(B_{1-λ}C_{λ})ₓA_{y}. Subscript λ may refer to the fraction of reversible groups within the reversible middle block. The fraction of reversible groups (λ) may have a significant effect on the physical properties of the triblock copolymer, such as the equilibrium shear modulus. In embodiments, the fraction of reversible groups (λ) may be at least about 0.05, such as at least 0.08, at least 0.10, at least 0.2, at least 0.4, at least 0.6, at least 0.7, at least 0.8, at least 0.9, from 0.1 to 1, from 0.2 to 1, from 0.4 to 1, from 0.5 to 1, from 0.6 to 1, from 0.7 to 1, from 0.9 to 1, or any subset thereof.

In embodiments, the reversible middle block may comprise at least 0.5 amide groups per Kuhn segment. Without being limited by theory, it is believed that the number of amide groups per Kuhn segment controls the number of (and therefore the cumulative strength of) the reversible bonds formed between the reversible middle blocks. In embodiments, the reversible middle block may comprise at least 0.6, at least 0.8, at least 1.0, at least 2, at least 4, at least 6, from 0.5 to 8.0, from 1 to 8, from 2 to 8, from 4 to 8, from 6 to 8, from 0.5 to 6, from 0.5 to 4, from 0.5 to 2, or any subset thereof of amide groups per Kuhn segment. It should be understood that in some embodiments λ=0 corresponds to 0 stickers per Kuhn segment, 2-0.084 corresponds to 0.7 stickers per Kuhn segment, 2-0.25 corresponds to 2 stickers per Kuhn segment, λ=0.52 corresponds to 4 stickers per Kuhn segment, λ=0.75 corresponds to 6 stickers per Kuhn segment, and λ=1 corresponds to 8 stickers per Kuhn segment. It is believed that a Kuhn segment in a polymer comprising HA and AAPA will have Kuhn length b=22 Å.

Referring again to the triblock copolymer of the structure A_{y}(B_{1-λ}C_{λ})ₓA_{y}, subscript x, referring to the degree of polymerization of the reversible middle block, may be from 200 to 1200. In embodiments, subscript x may be from 200 to 1000, from 200 to 800, from 200 to 600, from 200 to 400, from 200 to 280, from 200 to 265, from 220 to 300, from 220 to 280, from 220 to 265, from 240 to 300, from 240 to 280, from 240 to 265, from 250 to 300, from 250 to 270, or any subset thereof.

The A block may comprise residues of a small monomer. The residues of the small monomers may be polymerized together to form linear polymers. In embodiments, A may be is the residue of poly(benzyl methacrylate) (PBₙMA).

The A block may have a glass transition temperature (T_{g}) above the working temperature of the material, such that the A blocks aggregate to form nanoscale hard, glassy domains that act as crosslinks below their glass transition temperature. Without being limited by theory, it is believed that unlike covalent bonds, the glassy domains can dissociate at high temperatures or in the presence of solvents. Such stimuli-triggered reversibility may allow the polymers to be completely reprocessable. At relatively low temperature, the glassy nodules may effectively act as strong crosslinks and maintain the material integrity upon deformation. In embodiments, the A block may have a glass transition temperature of greater than 20° C., greater than 30° C., greater than 40° C., greater than 50° C., from 20° C. to 80° C., from 30° C. to 80° C., from 40° C. to 80° C., from 50° C. to 80° C., or any subset thereof.

A volume fraction (1) of the A block may be from 6% to 50%. The volume fraction (ƒ) of the A block refers to the percentage of space in the bulk polymer occupied by A blocks. It is believed that the volume fraction (ƒ) of the A blocks may help to control the storage moduli G′, the loss moduli G″, the equilibrium shear modulus, the stress-strain curves, and the tensile toughness of the polymer networks. It is believed that increasing volume fraction (ƒ) of the A block results in improved material qualities across all the listed characteristics. In embodiments, the volume fraction (ƒ) of the A block may be from 6% to 40%, from 6% to 35%, from 6% to 30%, from 6% to 20%, from 6% to 15%, from 10% to 40%, from 20% to 40%, from 30% to 40%, or any subset thereof.

Referring again to the triblock copolymer of the structure A_{y}(B_{1-λ}C_{λ})ₓA_{y}, subscript y, referring to the number of monomers per end block, may be from 10 to 100. Without being limited by theory, it is believed that the number of monomers per A block may help to control the volume fraction (ƒ) of the A blocks. In embodiments, subscript y may be from 20 to 100, from 30 to 100, from 40 to 100, from 10 to 80, from 10 to 60, from 10 to 50, from 10 to 40, from 10 to 30, from 10 to 20, from 20 to 100, from 20 to 80, from 20 to 60, from 20 to 40, from 15 to 65, from 15 to 40, or any subset thereof.

The LRL copolymer may have an absolute molecular weight (Mw) of from 20 kg/mol to 2000 kg/mol. In embodiments, the LRL copolymer may have a Mw of from 20 kg/mol to 2000 kg/mol, from 40 kg/mol to 2000 kg/mol, from 60 kg/mol to 2000 kg/mol, from 75 kg/mol to 2000 kg/mol, from 100 kg/mol to 2000 kg/mol, from 150 kg/mol to 2000 kg/mol, from 250 kg/mol to 2000 kg/mol, from 500 kg/mol to 2000 kg/mol, from 750 kg/mol to 2000 kg/mol, from 1000 kg/mol to 2000 kg/mol, from 1250 kg/mol to 2000 kg/mol, from 1500 kg/mol to 2000 kg/mol, from 20 kg/mol to 1500 kg/mol, from 20 kg/mol to 1250 kg/mol, from 20 kg/mol to 1000 kg/mol, from 20 kg/mol to 750 kg/mol, from 20 kg/mol to 500 kg/mol, from 20 kg/mol to 250 kg/mol, from 20 kg/mol to 150 kg/mol, from 20 kg/mol to 100 kg/mol, from 20 kg/mol to 75 kg/mol, from 20 kg/mol to 50 kg/mol, or any subset thereof.

The LRL copolymer may have a polydispersity index (PDI) of from 1.0 to 1.5. In embodiments, the LRL copolymer may have a PDI of from 1.0 to 1.4, from 1.0 to 1.3, from 1.1 to 1.5, from 1.2 to 1.5, from 1.1 to 1.4, from 1.2 to 1.3, or any subset thereof. The PDI may be determined by gel permeation chromatography (GPC).

The LRL copolymer may form a polymer network. The polymer network may be substantially free of solvents. Solvents may include water, organic solvents, and alcohols. In embodiments, the substantially solvent free polymer network may comprise less than 10 wt. %, such as less than 5 wt. %, less than 3 wt. %, less than 1 wt. %, or even less than 0.1 wt. % of solvent.

The LRL copolymer may have a tensile strength of at least 1 megapascal (MPa). In embodiments, the LRL copolymer may have a tensile strength of at least 1.5 MPa, at least 2.0 MPa, at least 2.5 MPa, or at least 3.0 MPa.

The LRL copolymer may have a network breaking strain of at least 1.2. In embodiments, the LRL copolymer may have a network breaking strain of at least 1.25, at least 1.30, at least 1.35, at least 1.40, at least 1.45, at least 1.50, at least 1.55, from 1.25 to 1.8, or any subset thereof.

The LRL copolymer may have a network tensile toughness of at least 0.5 MJ/m³. In embodiments, the LRL copolymer may have a network tensile toughness of at least 0.8 MJ/m³, at least 1.0 MJ/m³, at least 1.1 MJ/m³, or at least 1.2 MJ/m³.

The LRL copolymer may be self-healing. A polymer is self healing if it can be cut into two pieces and the pieces will reconnect under appropriate conditions.

The LRL copolymer may be transparent to visible light.

The LRL copolymer may comprise glassy domains. The existence of glassy domains may be confirmed by crystallographic methods, such as small angle x-ray scattering (SAXS).

A method of recycling the LRL copolymer may comprise dissolving the LRL copolymer in a solvent; and evaporating the solvent. A solvent capable of temporarily disrupting the reversible bonds may be used. In embodiments, the solvent may be an organic solvent, such as dichloromethane.

Dissolving the LRL copolymer in a solvent may comprise contacting the LRL copolymer with the solvent for a time sufficient to dissolve the LRL copolymer, such as at least 5 min, at least 10 min, at least 20 min, at least 40 min, or at least 1 hour. The LRL copolymer may contact the solvent at a temperature of at least 20° C., such as at least 40° C., at least 60° C., at least 80° C., from 20° C. to 100° C., from 40° C. to 100° C., from 60° C. to 100° C., from 80° C. to 100° C., or any subset thereof.

Evaporating the solvent may comprise allowing the solvent to evaporate. For example, evaporating the solvent may comprise leaving the solution to sit out at room temperature, or at an elevated temperature. In embodiments, evaporating the solvent may occur at atmospheric pressure, or at a reduced pressure.

The material properties (e.g. rheological and tensile properties) of the LRL copolymer may not be significantly altered by reprocessing. In embodiments, the glass transition temperature, degree of polymerization, percentage of reversible groups 2, network breaking strain, tensile toughness, tensile strength, viscosity, or other properties may not be altered by more than 25%, such as by less than 20%, less than 10%, less than 5%, or less than 1% by the recycling process, relative to the raw LRL copolymer.

A method of synthesizing the linear-reversible-linear (LRL) copolymer may comprise copolymerizing a sticky monomer and a spacer monomer to form a random copolymer; and copolymerizing the random copolymer with a small monomer to form the LRL copolymer.

The method may begin by synthesizing the sticky monomer. Synthesizing the sticky monomer may comprise combining an amino containing compound with an acetate; combining the amino containing compound and the acetate with acetic anhydride to form a first monomer solution; introducing an alcohol and a carbonate to the first solution to produce a second monomer solution; evaporating solvent from the second solution to produce a first acetamido compound; combining the acetamido compound with acrylic acid, a crosslinking agent, and a solvent to produce a third monomer solution; and evaporating solvent from the third solution to produce a crude sticky monomer; and purifying the crude sticky monomer to produce the sticky monomer.

The amino containing compound may comprise 5-amino-1-pentanol. The acetate may comprise ethyl acetate. The alcohol may comprise methanol. The carbonate may comprise K₂CO₃.

The solvent may comprise dichloromethane. The crosslinking agent may comprise 1-ethyl-3-[3-dimethylaminopropyl]carbodiimide hydrochloride. Purifying the crude sticky monomer may comprise passing the crude sticky monomer through a silica column using ethyl acetate/hexanes as eluent

It should be understood that in some embodiments, the sticky monomer may be purchased by the end user, rather than synthesized by the end user.

Copolymerizing the sticky monomer and the spacer monomer to form a random copolymer may be done by the activators-regenerated-by-electron-transfer (ARGET) atom transfer radical polymerization (ATRP) method. Specifically, copolymerizing the sticky monomer and the spacer monomer may comprise: combining an initiator (such as 2f-BiB), anisole, the sticky monomer, and the spacer monomer to produce a first random copolymer solution; combining the sticky monomer and the spacer monomer with a catalyst solution; introducing a reducing agent to the first random copolymer solution, thereby producing a second random copolymer solution; reacting the second random copolymer solution, thereby producing a crude random copolymer; and purifying the crude random copolymer to form the random copolymer. The catalyst solution may comprise tris [2-(dimethylamino)ethyl]amine (Me₆TREN) and CuCl₂ in a solvent. The solvent may comprise dimethylformamide. The reducing agent may comprise tin (II) 2-ethylhexanoate (Sn(EH)₂).

Copolymerizing the random copolymer with a small monomer to form the LRL copolymer may be done by the activators-regenerated-by-electron-transfer (ARGET) atom transfer radical polymerization (ATRP) method. Specifically, copolymerizing the random copolymer with the small monomer may comprise: combining a methacrylate compound, the random copolymer, and anisole; combining the methacrylate compound and the random copolymer with a catalyst solution, thereby producing a first LRL solution; reacting the first LRL solution to produce a crude LRL copolymer; and purifying the crude LRL copolymer, thereby producing the LRL copolymer. The methacrylate compound may comprise benzyl methacrylate. The catalyst solution may comprise tris [2-(dimethylamino)ethyl]amine (Me₆TREN) and CuCl₂ in a solvent. The solvent may comprise dimethylformamide. A reducing agent may be added with the catalyst solution. The reducing agent may comprise tin (II) 2-ethylhexanoate (Sn(EH)₂).

Purifying each of the crude random copolymer and the crude LRL copolymer may comprise passing the crude polymer through a silica column using ethyl acetate/hexanes.

A method of additive manufacturing may comprise 3-d printing an article using an LRL copolymer as the feedstock. 3-d printing an article using an LRL copolymer as the feedstock may comprise heating the LRL copolymer and extruding the LRL copolymer onto a surface to form a single layer of an article; and extruding more of the LRL copolymer over the single layer of the article to form a second layer, thereby forming an article with a predefined shape.

The material properties (e.g. rheological and tensile properties) of the LRL copolymer may not be significantly altered by 3-d printing. In embodiments, the glass transition temperature, degree of polymerization, 2, network breaking strain, tensile toughness, tensile strength, viscosity, or other properties may not be altered by more than 25%, such as by less than 20%, less than 10%, less than 5%, or less than 1% by the 3-d printing process, relative to the raw LRL copolymer.

### Test Methods

### Glass Transition Temperature (T_{g})

Differential scanning calorimetry (DSC) is used to quantify the T_{g}. Unless specifically stated otherwise, the T_{g} refers to the T_{g} of the entangled polymer. A temperature modulated differential scanning calorimeter (TMDSC) DSC250 (TA instruments) from 308K to 193K at a cooling rate of 2 K/min with a modulation rate of 1 K/min and a modulation frequency of 60 Hz is used. Before characterization all the samples are dried at room temperature (˜293 K) under vacuum (30 mbar) for at least 24 hours. A standard aluminum DSC pan is used for all the measurements. The absolute specific heat capacity, Cp, is determined through measurements of first the empty pan (the calibration line) and then the same pan with 10 mg samples following the same cooling protocol. The T_{g} values are then determined as the peak of the derivative of the heat capacity versus temperature.

### Absolute Molecular Weight

The absolute molecular weight may be determined by high-pressure liquid chromatography (HLPC) or gel permeation chromatography (GPC).

### Tensile Testing

To prepare a sample for tensile testing, the triblock copolymer is dissolved in dichloromethane at a concentration of 300 mg/mL in a glass vial. Then, the solution is transferred to a Teflon mold and the solvent is allowed to slowly evaporate for 24 hours to avoid the formation of bubbles in the sample. A polymer film with thickness of 0.5 mm is formed and peeled off from the Teflon mold. The film is cut into three identical rectangular pieces with length of 1.5 cm and width of 2.5 mm. The two ends of the film are glued to two pieces of hard paper using epoxy with a gap of 5 mm.

The tensile test may be performed using a load cell (such as a Mark-10 ESM303) with 10 N maximum force and a moving stage. The two hard papers are fixed to the load cell and the moving stage, respectively. Uniaxial tensile measurements are conducted at room temperature in air under strain rates of 0.01 s⁻¹. The strain is measured by monitoring the change of the tensile stress. Each measurement is repeated at least three times. Tensile toughness may be calculated from the tensile testing.

### Rheometry

Rheological measurements are performed using a stress-controlled rheometer (such as an Anton Paar MCR 302) equipped with a plate-plate geometry of diameter 8 mm. The LRL copolymer are dissolved in dichloromethane to make a homogenous mixture with concentration of 300 mg/mL. About 1 mL solution is pipetted onto the bottom plate, the solution is allowed to dry in the air at room temperature, and then the bottom plate is heated to 40° C. for an additional 20 min. This allows the preparation of a relatively thick film, ˜0.3 mm, without the formation of cavities due to the evaporation of solvent. Then, the upper plate is lowered and the excess sample is trimmed.

For a frequency sweep at various temperatures, the oscillatory shear strain is fixed at 0.5% while varying the shear frequency from 0.1 rad/sec to 100 rad/sec. When changing temperature, a slow temperature ramping rate (e.g. 1° C./minute) is used. The temperature is held at each point for 2 minutes before collecting data; this ensures that the self-assembled microstructure is in equilibrium at each temperature point. Network stiffness and network breaking strain can be measured from the rheological and tensile measurements.

### Small Angle X-Ray Scattering (SAXS)

To prepare a sample for SAXS measurement, a triblock copolymer is dissolved in dichloromethane at a concentration of 300 mg/mL in a glass vial. Then 150-μL of solution is placed on a 1.2 cm×1.2 cm glass substrate and the solvent is allowed to slowly evaporate for 24 hours. For each sample, the smallest dimension after solvent evaporation is larger than 0.5 mm (i.e. more than 104 times the size of a triblock copolymer), this prevents substrate or boundary effects from altering the results.

The Soft Matter Interfaces (12-ID) beamline at the Brookhaven National Laboratory was used to perform SAXS measurements on annealed bulk polymers. The sample-to-detector distance was 8.3 meters, and the radiation wavelength was λ=0.77 Å. The scattered X-rays were recorded using an in-vacuum Pilatus 1M detector, consisting of 0.172 mm square pixels in a 941×1043 array. The raw SAXS images were converted into q-space, visualized in Xi-CAM software, and radially integrated using a custom Python code. The one-dimensional intensity profile, I(q), was plotted as a function of the scattering wave vector,

$$\vert \overline{q} \vert = q = 4 {πλ}^{- 1} sin ( \frac{θ}{2} ) ,$$

where θ was the scattering angle.

### Examples

The following examples illustrate one or more features of the present disclosure. It should be understood that these examples are not intended to limit the scope of the disclosure or the appended claims in any manner. Where values are not provided in the tables below, the parameter was not recorded.

Materials: Hexyl acrylate (98%), acetic anhydride (≥98%), 5-amino-1-pentanol (≥92%), acrylic acid (99%), K₂CO₃ (≥99%), N-(3-Dimethylaminopropyl)-N′-ethylcarbodiimide hydrochloride (EDC, 98%), N,N-diisopropylethylamine (≥99%), benzyl methacrylate (96%), Copper (II) chloride (CuCl₂, 99.999%), tris [2-(dimethylamino)ethyl]amine (Me₆TREN), ethylene bis(2-bromoisobutyrate) (2-BiB, 97%), Tin (II) 2-ethylhexanoate (Sn(EH)₂, 92.5-100%), anisole (≥99.7%) were purchased from Sigma Aldrich and used as received. Methanol (Certified ACS), ethyl acetate (Certified ACS), hexanes (Certified ACS), dichloromethane (Certified ACS), diethyl ether (Certified ACS), dimethylformamide (DMF, Certified ACS), tetrahydrofuran (THF, Certified ACS) and THF (HPLC), were purchased from Fisher and used as received.

Polymer Synthesis: The synthesis of a linear-reversible-linear (LRL) triblock copolymer comprises three steps: (1) synthesis of the sticky monomer, (2) synthesis of the reversible middle block, and then (3) using the middle block as a macro-initiator to grow the two end linear blocks. For both steps, activators regenerated by electron transfer (ARGET) atom transfer radical polymerization (ATRP) was used. The reversible block was synthesized by copolymerizing hexyl acrylate (HA) with 5-acetamidopentyl acrylate (AAPA), which carries an amide group at one of its two ends and served as the sticky monomer.

Step I. Synthesis of sticky monomer 5-acetamido pentyl acrylate (AAPA). First, a flask was charged with 5-amino-1-pentanol (25 g, 242.3 mmol) and ethyl acetate (250 mL). Acetic anhydride (28.1 g, 275.4 mmol) was added dropwise with vigorous stirring under nitrogen. After finishing the addition of acetic anhydride, the reaction mixture was stirred at room temperature for 2 hours followed by the addition of methanol (80 mL) and K₂CO₃ (28 g, 202.6 mmol). The mixture was vigorously stirred for another 15 min followed by the filtration of undissolved solids (if any were present). The filtered solution was concentrated by a rotary evaporator (Buchi R-205) to obtain 5-acetamido-1-pentanol (AAPA, 30.5 g) with a yield of 87.1%. The synthesis of AAPA was confirmed by ¹H NMR (600 MHZ, CDCl₃) δ=3.53 (t, 2H), 3.14 (q, 2H), 1.89 (s, 3H), 1.47 (m, 4H), 1.32 (m, 4H).

Second, a flask was charged with 5-acetamido-1-pentanol (3.34 g, 23.0 mmol), acrylic acid (2.48 g, 34.5 mmol), EDC (7.27 g, 37.9 mmol), N,N-diisopropylethylamine (4.9 g, 37.9 mmol) and dichloromethane (100 mL). The reaction was stirred at room temperature for 48 h under nitrogen. Then the reaction mixture was diluted with another 100 mL dichloromethane. Then the solution was sequentially washed with aqueous solutions of NaOH (1.0 M, 100 mL), aqueous solution of HCl (1.0 M, 100 mL), saturated aqueous solutions of NaHCO₃ (150 mL) and saturated aqueous solution of NaCl (150 mL) The organic supernatant was dried with Na₂SO₄ for 12 h and then concentrated by a rotary evaporator to obtain the crude product. The crude product was purified by passing through a silica column using ethyl acetate/hexanes=1/9 (v/v) as eluent. 5-acetamido pentyl acrylate (AAPA) (3.6 g) was obtained with a yield of 78.6%. ¹H NMR (600 MHz, CDCl₃) δ=6.37 (d, 1H), 6.11 (dd, 1H), 5.82 (d, 1H), 5.58 (s, 1H), 4.15 (t, 2H), 3.23 (q, 2H), 1.96 (s, 3H), 1.68 (m, 2H), 1.53 (m, 2H), 1.39 (m, 2H).

Step II-a. Representative Synthesis of control middle block poly(hexyl acrylate) (PHA). A 25 mL Schlenk flask was charged with 2f-BiB (23 mg, 0.064 mmol), hexyl acrylate (5 g, 32.0 mmol) and anisole (6 mL). Me₆TREN (92 mg, 0.4 mmol) and CuCl₂ (5.4 mg, 0.04 mmol) was dissolved in 1 mL DMF to make a catalyst solution. Then, 160-μL catalyst solution, containing 6.4×10⁻² mmol Me₆TREN and 6.4×10⁻³ mmol CuCl₂, was added to the mixture and the mixture was bubbled with nitrogen for 30 min to remove oxygen. Afterward, the reducing agent, Sn(EH)₂ (52 mg, 0.128 mmol) in 200 μL anisole, was quickly added to the reaction mixture using a glass pipet. The flask was sealed and then immersed in an oil bath at 80° C. to start the reaction. The reaction was monitored by taking out a small amount of mixture every 30 mins to determine the conversion using ¹H NMR. The reaction was stopped after 126 min. Based on ¹H NMR, the conversion was 50.2%, and the degree of polymerization (DP) is 251. The percentage of sticky monomers was zero percent (λ=0.00).

The reaction mixture was diluted with THF and passed through a neutral aluminum oxide column to remove the catalyst. The collected solution was concentrated by a rotary evaporator. Methanol was used to precipitate the polymer. The sediment was then re-dissolved in THF to make a homogenous solution, and this precipitation procedure was repeated another 2 times to ensure that all unreacted monomers and impurities were completely removed. After purification, the sample was dissolved in THF and transferred to a glass vial and dried in the hood for 16 h, then transferred to a vacuum oven (Thermo Fisher, Model 6258) at room temperature for 24 h to completely remove the solvent. The reaction conditions for the synthesis are summarized in Table 1.

Step II-b. Representative Synthesis of reversible middle block with 8.8% of sticky monomers (λ=0.088): A 25 mL Schlenk flask was charged with 2f-BiB (22.4 mg, 0.062 mmol), hexyl acrylate (4.38 g, 28.0 mmol), AAPA (0.62 g, 3.11 mmol) and anisole (6 mL). Me₆TREN (92 mg, 0.4 mmol) and CuCl₂ (5.4 mg, 0.04 mmol) were dissolved in 1 mL DMF to make a catalyst solution. Then, 155 μL of catalyst solution, containing 6.2×10⁻² mmol Me₆TREN and 6.2×10⁻³ mmol CuCl₂, was added to the mixture and it was bubbled with nitrogen for 30 min to remove oxygen. Afterwards, the reducing agent, Sn(EH)₂ (50.4 mg, 0.125 mmol) in 200 μL anisole, was quickly added to the reaction mixture using a glass pipet. The flask was sealed and then immersed in an oil bath at 80° C. to start the reaction. The reaction was monitored by taking out a small amount of mixture to determine the conversion using proton NMR and stopped after 109 min. From proton NMR, the conversion was 52.4% and the total degree of polymerization (DP) was 262. The purification procedure was the same as the synthesis of the control middle block. After purification, from ¹H NMR, the DP of hexyl acrylate was 239, the DP of AAPA was 23, the percentage of sticky bonds was 8.8% or (λ=0.088). The reaction was repeated at different reaction conditions to achieve different 2 values, as summarized in Table 1 below. Details of the resulting polymers are given in Table 2 below.

Step II-c. Representative Synthesis of a reversible polymer with AAPA sticky monomer only. A 25 mL Schlenk flask was charged with 2f-BiB (12.6 mg, 0.035 mmol), AAPA (2.9 g, 14.6 mmol), and DMF (4.4 mL). Me₆TREN (92 mg, 0.4 mmol) and CuCl₂ (5.4 mg, 0.04 mmol) were dissolved in 1 mL DMF to make a catalyst solution. Then, 73 μL catalyst solution, containing 2.9×10−2 mmol Me₆TREN and 2.9×10⁻³ mmol CuCl₂, was added to the mixture and it was bubbled with nitrogen for 30 min to remove oxygen. Afterward, the reducing agent, Sn(EH)₂ (23.6 mg, 0.058 mmol) in 200 μL anisole, was quickly added to the reaction mixture using a glass pipet. The flask was sealed and then immersed in an oil bath at 65° C. to start the reaction. The reaction was monitored by taking out a small amount of mixture at different time points to determine the conversion using ¹H NMR and stopped after 75 min. From ¹H NMR, the conversion was 69.5% and the DP was 280. The purification procedure was similar to the synthesis of the reference polymer. The only difference was that diethyl ether is used for precipitation, which can dissolve AAPA but is a poor solvent for PAAPA. The purification was repeated 3 times to ensure that all unreacted monomers and impurities were removed. After purification, the sample was dissolved in methanol and transferred to a glass vial and dried in the hood for 16 h, and then transferred to a vacuum oven (Thermo Fisher, Model 6258) at room temperature for 48 h to completely remove the solvent.

TABLE 1
Synthesis Conditions for Middle Block Polymers

| | HA | AAPA | Initiator (2f- | Catalyst | Sn(EH)₂ |
|---|---|---|---|---|---|
| Sample | (mmol) | (mmol) | BIB) (mmol) | (μL) | (mmol) |
| CE-A | 76.8 | 0 | 0.154 | 384 | 0.307 |
| EX-1 | 25.6 | 1.07 | 0.053 | 133 | 0.107 |
| EX-2 | 28 | 3.11 | 0.062 | 156 | 0.125 |
| EX-3 | 22.4 | 7.53 | 0.060 | 150 | 0.120 |
| EX-4 | 11.3 | 11.3 | 0.045 | 113 | 0.091 |
| EX-5 | 4.5 | 13.55 | 0.043 | 90 | 0.072 |
| EX-6 | 0 | 14.1 | 0.035 | 73 | 0.058 |
| CE-B | 32 | 0 | 0.016 | 320 | 0.128 |
| EX-7 | 28 | 3.11 | 0.016 | 150 | 0.156 |
| EX-8 | 22.4 | 7.53 | 0.015 | 150 | 0.15 |
| CE-C | 32 | 0 | 0.064 | 160 | 0.128 |
| EX-9 | 28 | 3.11 | 0.062 | 156 | 0.125 |
| EX-10 | 22.4 | 7.53 | 0.060 | 150 | 0.119 |
| EX-11 | 22.4 | 7.53 | 0.060 | 150 | 0.119 |
| EX-12 | 22.4 | 7.53 | 0.060 | 150 | 0.119 |
| EX-13 | 22.4 | 7.53 | 0.060 | 150 | 0.119 |
| | Anisole | DMF | T | Time | Conv. |
| Sample | (mL) | (mL) | (° C.) | (min) | (%) |
| CE-A | 16 | 0 | 70 | 261 | 50.8 |
| EX-1 | 12 | 0 | 80 | 74 | 47.7 |
| EX-2 | 6.2 | 0 | 70 | 230 | 52.4 |
| EX-3 | 6 | 0 | 70 | 159 | 50.5 |
| EX-4 | 4.6 | 0 | 70 | 119 | 51.2 |
| EX-5 | 2 | 2 | 65 | 79 | 61.2 |
| EX-6 | 0 | 4.4 | 70 | 75 | 69.5 |
| CE-B | 6.4 | 0 | 80 | 304 | 50.5 |
| EX-7 | 6.2 | 0 | 80 | 258 | 51.0 |
| EX-8 | 6 | 0 | 89 | 223 | 49 |
| CE-C | 6 | | | 126 | 50.2 |
| EX-9 | 6 | | | 109 | 52.4 |
| EX-10 | 6 | | | 100 | 48.0 |
| EX-11 | 6 | | | 100 | 48.0 |
| EX-12 | 6 | | | 133 | 50 |
| EX-13 | 6 | | | 133 | 50 |

TABLE 2
Molecular Parameters of Reversible Middle Blocks

| | HAₓ-r-AAPA_{y} | | | | | |
|---|---|---|---|---|---|---|
| Sample | x | y | PDI | λ | M₀ (Da) | Mₙ (Da) |
| CE-A | 254 | 0 | 1.15 | 0 | 1359 | 39680 |
| EX-1 | 230 | 10 | 1.18 | 0.04 | 1375 | 37923 |
| EX-2 | 229 | 21 | 1.14 | 0.084 | 1391 | 39959 |
| EX-3 | 189 | 64 | 1.18 | 0.25 | 1454 | 42278 |
| EX-4 | 123 | 133 | 1.18 | 0.52 | 1554 | 45715 |
| EX-5 | 64 | 191 | 1.28 | 0.75 | 1640 | 48055 |
| EX-6 | 0 | 280 | 1.61 | 1 | 1733 | 55790 |
| CE-B | 1009 | 0 | 1.5 | 0 | 1359 | 157626 |
| EX-7 | 927 | 93 | 1.49 | 0.09 | 1393 | 163346 |
| EX-8 | 725 | 255 | 1.32 | 0.26 | 1456 | 164068 |
| CE-C | 251 | 0 | 1.26 | 0 | | |
| EX-9 | 239 | 23 | 1.19 | 0.09 | | |
| EX-10 | 180 | 60 | 1.22 | 0.25 | | |
| EX-11 | 180 | 60 | 1.22 | 0.25 | | |
| EX-12 | 188 | 62 | 1.22 | 0.25 | | |
| EX-13 | 188 | 62 | 1.22 | 0.25 | | |

In Table 2, x represents the number of HA monomers; y represents the number of AAPA monomers; PDI is the polydispersity index; λ, fraction of AAPA monomers; M₀ is the mass of a Kuhn segment; Mₙ is the number average mass of a polymer determined by ¹H NMR.

As can be seen in Tables 1 and 2, the amount of adjusting the molar ratio between the sticky monomer AAPA and the spacer monomer HA controls the fraction of reversible groups 2. The absolute molecular weight (Mw) of the reversible middle block (M_{R}) is dependent on the molar ratio of the initiator to the spacer and sticky monomers.

The reversible middle blocks were then copolymerized with the small monomers to form the LRL copolymer of the present disclosure. The middle block copolymers synthesized above were used as the macroinitiator.

Representative Step III Synthesis of the control triblock copolymer: PBₙMA-PHA-PBₙMA. A 25 mL Schlenk flask was charged with benzyl methacrylate (BnMA, 705 mg, 4 mmol), macroinitiator (40 kg/mol, 800 mg, 0.02 mmol) and anisole (4 mL). Me₆TREN (92 mg, 0.4 mmol) and CuCl₂ (5.4 mg, 0.04 mmol) were dissolved in 1 mL DMF to make a catalyst solution. 40 μL catalyst solution, containing 1.6×10⁻² mmol Me₆TREN and 1.6×10⁻³ mmol CuCl₂, were added to the mixture and it was bubbled with nitrogen for 30 min to remove oxygen. Afterwards, reducing agent, Sn(EH)₂ (25.9 mg, 0.064 mmol) in 150 μL anisole, was quickly added to the reaction mixture using a glass syringe. Then, the flask was sealed and immersed in an oil bath at 60° C. The reaction was monitored by taking out a small amount of mixture to determine the DP of BnMA using ¹H NMR. The reaction was stopped after 120 min. The reaction mixture was diluted in THF and passed through a neutral aluminum oxide column to remove the catalyst, and the collected solution is concentrated by a rotavapor. The solution was precipitated with precipitation three times; this completely removed all unreacted monomers and impurities. After purification, the sample was dissolved in dichloromethane and transferred to a glass vial and dried in the hood for 16 h, then the vial was put in a vacuum oven at room temperature for 24 h to completely remove the solvent. After purification, from ¹H NMR, the DP of BnMA on each end was 15.

Representative Step III Synthesis of LRL triblock copolymers with reversible middle blocks. A 25 mL Schlenk flask was charged with benzyl methacrylate (BnMA, 583 mg, 3.31 mmol), macroinitiator (the reversible middle block) (42 kg/mol, 700 mg, 0.017 mmol), and anisole (3.3 mL). Me₆TREN (92 mg, 0.4 mmol) and CuCl₂ (5.4 mg, 0.04 mmol) were dissolved in 1 mL DMF to make a catalyst solution. 33 μL catalyst solution, containing 1.3×10⁻² mmol Me₆TREN and 1.3×10⁻³ mmol CuCl₂, was added to the mixture and it was bubbled with nitrogen for 30 min to remove oxygen. Afterwards, reducing agent, Sn(EH)₂ (21.5 mg, 0.053 mmol) in 150 μL anisole, was quickly added to the reaction mixture using a glass syringe. Then, the flask was sealed and immersed in an oil bath at 60° C. The reaction was monitored by taking out a small amount of mixture to determine the DP of BnMA using proton NMR. The reaction was stopped after 103 min. The purification procedure was the same as the synthesis of controlled triblock copolymer. After purification, from ¹H NMR, the DP of BnMA on each end was 18. The reaction conditions for the synthesis are summarized in Table 3.

TABLE 3
Synthesis conditions

| | | Macro- | | | | |
|---|---|---|---|---|---|---|
| | BnMA | initiator | Catalyst | Sn(EH)₂ | Anisole | Time |
| Sample | (mmol) | (mmol) | (μL) | (mmol) | (mL) | (min) |
| CE-C | 4 | 0.020 | 40 | 0.064 | 4 | 120 |
| EX-9 | 3.31 | 0.017 | 33 | 0.053 | 3.3 | 103 |
| EX-10 | 3 | 0.015 | 30 | 0.048 | 3 | 61 |
| EX-11 | 3.46 | 0.017 | 20 | 0.020 | 3.5 | 183 |
| EX-12 | 4.35 | 0.014 | 44 | 0.070 | 4.5 | 166 |
| EX-13 | 4.65 | 0.015 | 47 | 0.074 | 4.7 | 190 |

The parameters of the synthesized LRL copolymers are listed in Table 4 below.

TABLE 4

| | | | | | Tensile fracture |
|---|---|---|---|---|---|
| Sample | n_{BnMA} | f_{BnMA} (%) | PDI | G (Pa) | strain |
| CE-C | 30 | 10.4 | 1.28 | 2,524 | 1.22 ± 0.02 |
| EX-9 | 36 | 11.5 | 1.23 | 4,072 | 1.39 ± 0.05 |
| EX-10 | 32 | 10.8 | 1.26 | 10,546 | 1.57 ± 0.05 |
| EX-11 | 40 | 13.2 | 1.28 | 12,144 | 1.60 ± 0.17 |
| EX-12 | 102 | 27.3 | 1.35 | 67,245 | 0.95 ± 0.15 |
| EX-13 | 132 | 32.7 | 1.33 | 2,730,000 | 0.82 ± 0.06 |

| | SAXS | | | | | |
|---|---|---|---|---|---|---|
| | q* | d* | d | d_{b} | Lₘₐₓ | |
| Sample | (nm⁻¹) | (nm) | (nm) | (nm) | (nm) | Type |
| CE-C | 0.172 | 36.5 | 44.7 | 20.8 | 64.3 | S |
| EX-9 | 0.171 | 36.7 | 44.9 | 20.1 | 67.1 | S |
| EX-10 | 0.194 | 32.4 | 39.7 | 18.2 | 61.4 | S |
| EX-11 | 0.218 | 28.8 | 35.3 | 14.8 | 61.4 | S |
| EX-12 | 0.160 | 39.2 | 45.3 | 20.4 | 64.0 | Hex |
| EX-13 | 0.168 | 37.4 | 37.4 | 25.2 | 64.0 | Lam |

To calculate the degree of polymerization (DP), the fraction of reversible groups 2, and the volume fraction of linear polymer ƒ, ¹H-NMR testing was done.

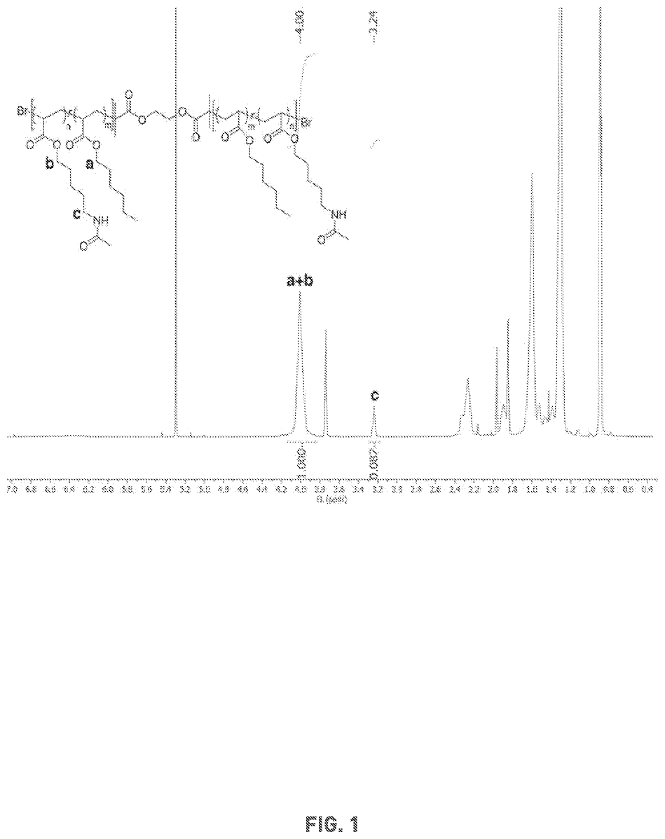

Calculation of the fraction of reversible groups in reversible middle block. In FIG. 1, the area of peak a A_{PHA-O} and peak b A_{PAAPA-O} at 4.00 ppm corresponds to two H on the methylene group connected with the oxygen atom in HA and AAPA repeating units, respectively. The area of peak c A_{PAAPA-N} at 3.24 ppm corresponds to two H on the methylene group connected with the nitrogen atom in AAPA repeating units. The fraction of reversible groups equals A_{PAAPA-N}×100%/(A_{PHA-O}+A_{PAAPA-O}). The fraction of reversible groups in FIG. 1 equals 0.087×100%/1=8.7%. For this middle block copolymer, the total DP for HA and AAPA was 262. Therefore, the DP of AAPA was 262×8.7%=23, the DP of HA is 262−23=239.

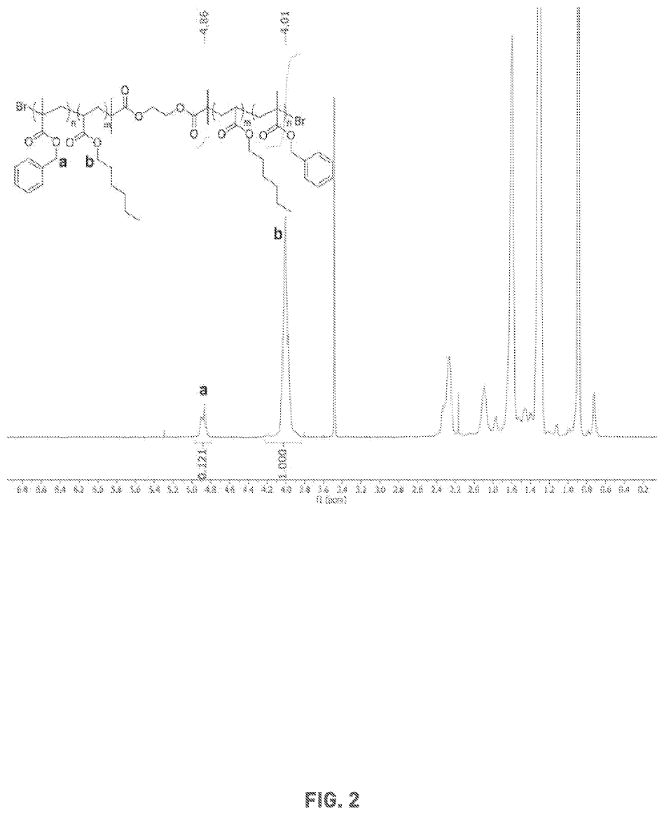

Calculation of DP and volume fraction of end block PBₙMA for the control triblock copolymer. The volume fraction of PBₙMA was determined based on the NMR spectra of purified triblock copolymers. For example, in FIG. 2, the area of peak a at 4.86 ppm, A_{PBnMA}, corresponds to the two H on the methylene group of benzyl methacrylate repeating unit of PBₙMA. The area of peak at 4.01 ppm, A_{PHA}, corresponds to two H on the methylene group connected with the oxygen atom in hexyl acrylate repeating unit of PHA. Therefore, the DP of PBₙMA is n_{BnMA}=n_{HA}×(A_{PBnMA}/2)/(A_{PHA}/2)=30, in which A_{BnMA}=0.121, A_{PHA}=1.000, and the DP of HA is n_{HA}=251. The volume fraction of PBₙMA is given by ƒ=(n_{BnMA}×m_{BnMA}/d_{PBnMA})/(n_{BnMA}×M_{BnMA}/d_{PBnMA}+n_{HA}×m_{HA}/d_{PHA})×100%=10.4%, in which the density of PBnMA is 1.179 g/mL, the density of PHA is 1.04 g/mL, the mass of a BnMA monomer m_{BnMA}=176.21 g/mol, and that of a HA monomer m_{HA}=156.23 g/mol.

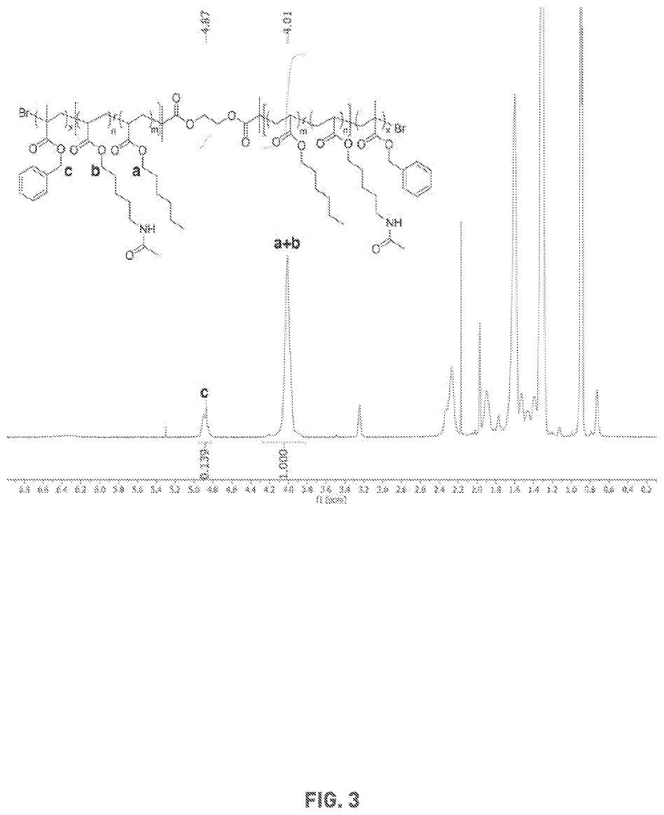

Calculation of DP and volume fraction of end block PBₙMA for reversible triblock copolymers. The volume fraction of PBₙMA was determined based on the NMR spectra of purified triblock copolymers. For example, in FIG. 3, the area of peak c at 4.87 ppm is A_{PBnMA}, corresponds to the two H on the methylene group of benzyl methacrylate repeating unit. Area of peak at 4.01 ppm is the total area a A_{PHA} and bA_{PAAPA}, corresponds to two H on the methylene group connected with the oxygen atom in HA and AAPA repeating units, respectively. Therefore, the degree of polymerization of PBnMA is n_{BnMA}=n_{HA}×(A_{PBnMA}/2)/((A_{PHA}+A_{PAAPA})/2)=36, in which A_{BnMA}=0.139, A_{PHA}+A_{PAAPA}=1.000, and the DP of HA is n_{HA}=239, DP of AAPA is n_{AAPA}=23. The volume fraction of PBnMA is given by ƒ=(n_{BnMA}×m_{BnMA}/d_{PBnMA})/(n_{BnMA}×m_{BnMA}/d_{PBnMA}+n_{HA}×m_{HA}/d_{PHA}+n_{AAPA}×m_{AAPA}/d_{PAAPA})×100%=11.5%, in which the density of PBnMA is 1.179 g/mL, the density of PHA and PAAPA is 1.04 g/mL, the mass of a BnMA monomer m_{BnMA}=176.21 g/mol, the mass of a HA monomer m_{HA}=156.23 g/mol and the mass of a AAPA monomer m_{HA}=199.25 g/mol.

Gel permeation chromatography (GPC) characterization. GPC was used to determine the polydispersity index (PDI) of polymers. GPC measurements were performed using TOSOH EcoSEC HLC-8320GPC system with two TOSOH Bioscience TSKgel GMHHR-M 5 μm columns in series and a refractive index detector at 40° C. HPLC grade THF is used as the eluent with a flow rate of 1 mL/min. The samples are dissolved in THF with a concentration around 5 mg/mL. The PDI data is shown in Tables 2 and 4.

Rheometry. Rheological measurements were performed using a stress-controlled rheometer (Anton Paar MCR 302) equipped with a plate-plate geometry of diameter 8 mm. The solvent reprocessability of LBBL polymer was exploited to prepare samples in situ. Specifically, LRL polymers were dissolved in dichloromethane to make a homogenous mixture with concentration of 300 mg/mL. About 1 mL solution was pipetted onto the bottom plate, allowed to dry in the air at room temperature, and then the bottom plate was heated to 40° C. for an additional 20 min. This allowed the preparation of a relatively thick film, ˜0.3 mm, without the formation of cavities due to the evaporation of solvent. Then, the upper plate was lowered and the excess sample was trimmed at the edge of the geometry.

For frequency sweep at various temperatures, we fix the oscillatory shear strain at 0.5% while varying the shear frequency from 0.1 rad/sec to 100 rad/sec. When changing temperature, we use a slow temperature ramping rate, 1° C./minute, and wait for 2 minutes at each temperature point before collecting data; this ensures that the self-assembled microstructure is in equilibrium at each temperature point.

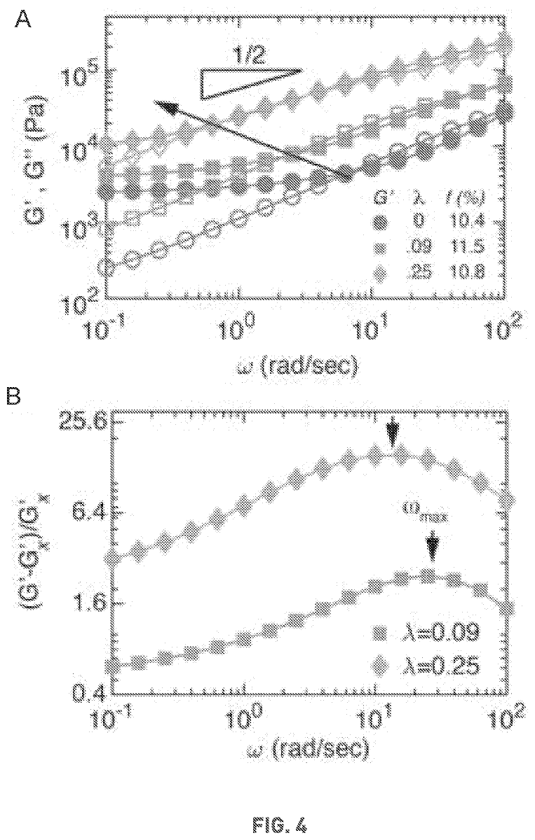

FIG. 4(a) shows the effect of λ and ƒ on the storage (solid symbols, G′) and loss (empty symbols, G″) moduli of the self-assembled polymer networks measured at 20° C. at a fixed strain of 0.5%. The slope ½ corresponds to the Rouse dynamics of the network strands. FIG. 4(b) shows the effect of λ on shear storage modulus (G′−G′ₓ)/G′ₓ, in which G′ₓ is shear storage modulus of the polymer without reversible bonds.

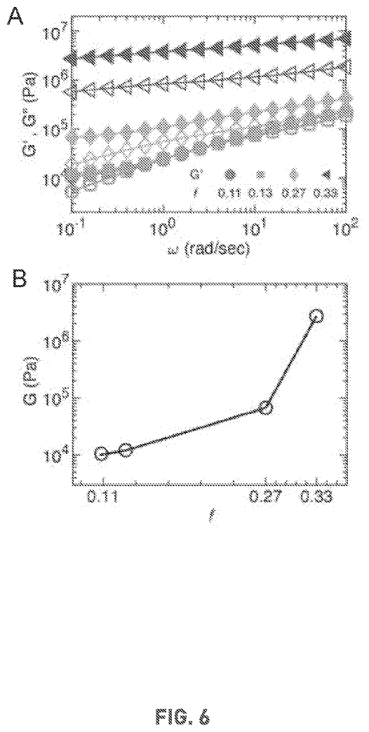

FIG. 6(a) shows the effect of ƒ on the storage (solid symbols, G′) and loss (empty symbols, G″) moduli of the self-assembled polymer networks measured at 20° C. at a fixed strain of 0.5%. The slope ½ corresponds to the Rouse dynamics of the network strands. FIG. 6(b) shows the dependence of equilibrium shear modulus (G) on ƒ.

Tensile test. To prepare a sample for tensile test, a triblock copolymer was dissolved in dichloromethane at a concentration of 300 mg/mL in a glass vial. Then, the solution was transferred to a Teflon mold and the solvent was allowed to slowly evaporate for 24 hours to avoid the formation of bubbles in the sample. The polymer film with thickness of 0.5 mm was formed and peeled off from the Teflon mold. The film was cut into three identical rectangular pieces with length of 1.5 cm and width of 2.5 mm. The two ends of the film were glued to two pieces of hard paper using epoxy with a gap of 5 mm.

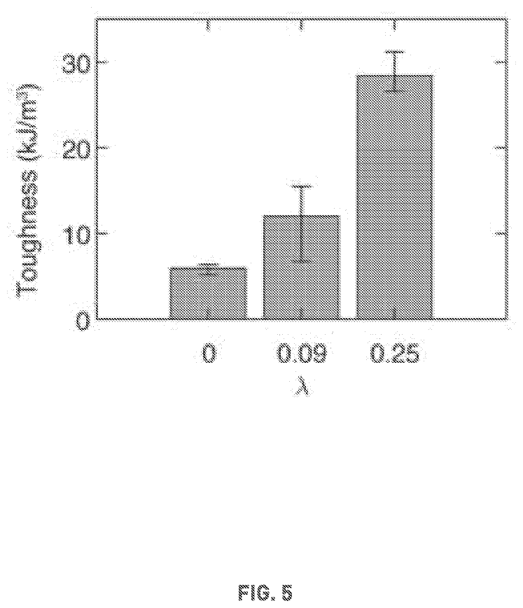

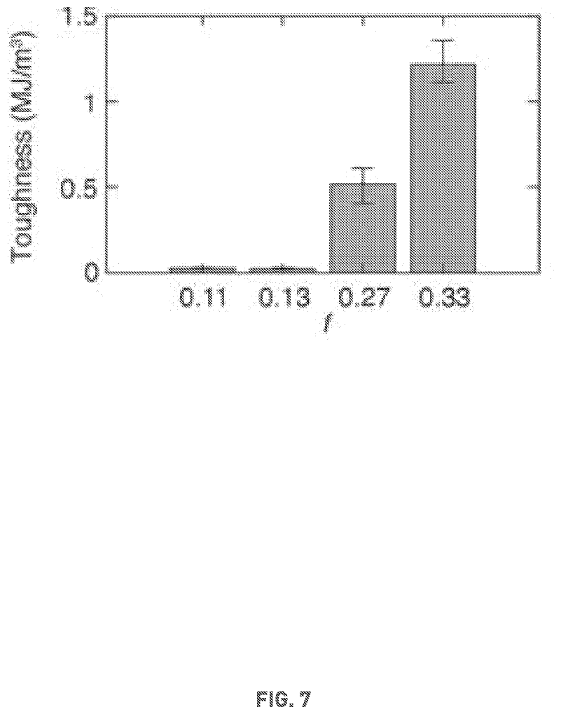

The tensile test was performed using a Mark-10 ESM303 load cell with 10 N maximum force and a moving stage. The two hard papers were fixed to the load cell and the moving stage, respectively. Uniaxial tensile measurements were conducted at room temperature in air under strain rates of 0.01 s⁻¹. The strain was measured by monitoring the change of the tensile stress using MESUR Mark-10 software. Each measurement is repeated at least three times. This data is reported in Table 4. The dependence of tensile toughness on 2 is shown in FIG. 5 and FIG. 7.

To demonstrate the reprocessability of the self-assembled elastomers, the elastomer was cut into small pieces, dissolved in dichloromethane, and re-dried to obtain an elastomer. From tensile test, the solvent-reprocessed elastomer exhibits negligible changes in stress-strain curves, as shown in FIG. 7.

SAXS measurements. To prepare a sample for SAXS measurement, a triblock copolymer was dissolved in dichloromethane at a concentration of 300 mg/mL in a glass vial. Then 150 μL solution was added on a 1.2 cm×1.2 cm glass substrate and the solvent was allowed to slowly evaporate for 24 hours. For each sample, the smallest dimension after solvent evaporation was larger than 0.5 mm, more than 104 times the size of a triblock copolymer; this prevented substrate or boundary effects on self-assembly.

The Soft Matter Interfaces (12-ID) beamline at the Brookhaven National Laboratory was used to perform SAXS measurements on annealed bulk polymers. The sample-to-detector distance was 8.3 m, and the radiation wavelength was λ=0.77 Å. The scattered X-rays were recorded using an in-vacuum Pilatus 1M detector, consisting of 0.172 mm square pixels in a 941×1043 array. The raw SAXS images were converted into q-space, visualized in Xi-CAM software and radially integrated using a custom Python code. The one-dimensional intensity profile, I(q), was plotted as a function of the scattering wave vector, |\vec{q}|=q=4πλ⁻¹ sin (θ/2), where θ is the scattering angle.

The LRL and control triblock copolymers with volume fraction ƒ of PBnMA around 0.11 self-assemble into sphere structure. The domain distance calculated from SAXS measurements almost doesn't change when λ increases to 0.09 but has an abrupt decrease from 44.7 nm to 39.7 nm when λ increases to 0.25. This contrast to the behavior of conventional triblock copolymers without reversible bonds, in which the domain distance is constant at fixed molecular weight and weight fraction of end blocks. Such a difference is likely attributed to the intramolecular interactions of stickers on the middle block, which help balance the interfacial repulsion between the incompatible end and middle blocks to result in less stretched network strands.

For LRL triblock copolymers with same λ and similar DP of middle block, when increases from 0.11 to 0.32, the self-assembled microstructure changes from BCC sphere (ƒ=0.11, 0.13) to hexagonal cylinder (ƒ=0.27) to lamellae (ƒ=0.32). Concurrently, the bridging distance increases with ƒ, consistent with the understanding of block copolymer self-assembly, in which the middle block is further stretched to balance the increased interfacial repulsion between the incompatible blocks.

1. A linear-reversible-linear (LRL) copolymer comprising an A (BC) A triblock copolymer, wherein:
the A (BC) A triblock copolymer comprises an A block and a BC block;
the A block comprises a linear polymer; and
the BC block comprises a copolymer with the ability to form reversible bonds.

2. The LRL copolymer of claim 1, wherein B is the residue of a spacer monomer, and C is the residue of a sticky monomer.

3. The LRL copolymer of claim 2, wherein each sticky monomer comprises a single amide group.

4. The LRL copolymer of claim 1, wherein the triblock copolymer has the structure A_{y}(B_{1-λ}C_{λ})ₓA_{y}.

5. The LRL copolymer of claim 1, wherein a volume fraction (ƒ) of the A block is from 6% to 40%.

6. The LRL copolymer of claim 4, wherein subscript λ (representing the fraction of reversible groups) is at least about 0.05.

7. The LRL copolymer of claim 4, wherein:
the A blocks have a glass transition temperature above 20° C.; and
the BC block has a glass transition temperature below 20° C.

8. The LRL copolymer of claim 4, wherein the subscript x (the degree of polymerization of the BC block) is from 200 to 300.

9. The LRL copolymer of claim 1, wherein the LRL copolymer has an absolute molecular weight (Mw) of from 20 kg/mol to 40 kg/mol.

10. The LRL copolymer of claim 4, wherein
A is a residue of poly(benzyl methacrylate) (PBₙMA);
B is a residue of hexyl acrylate (HA); and
C is a residue of 5-acetamido-1-pentyl acrylate (AAPA).

11. The LRL copolymer of claim 1, wherein the LRL copolymer has a tensile strength of at least 1 MPa.

12. The LRL copolymer of claim 1, wherein the LRL copolymer has a network breaking strain of at least 1.2.

13. The LRL copolymer of claim 1, wherein the LRL copolymer has a network tensile toughness of at least 1 MJ/m³.

14. The LRL copolymer of claim 1, wherein:
the triblock copolymer has the structure A_{y}(B_{1-λ}C_{λ})A_{y};
A is a residue of poly(benzyl methacrylate) (PBₙMA), B is a residue of hexyl acrylate (HA), and C is a residue of 5-acetamido-1-pentyl acrylate (AAPA);
a volume fraction (ƒ) of the A block is from 6% to 40%;
a fraction of reversible groups (λ) is from 0.05 to 1.0;
the reversible middle block comprises from 0.5 to 8 amide groups per Kuhn segment of the reversible middle block;
the A blocks have a glass transition temperature above 20° C.; and
the BC block has a glass transition temperature below 20° C.

15. A method of recycling the LRL copolymer of claim 1, wherein the method comprises:
dissolving the LRL copolymer in a solvent; and
evaporating the solvent.

16. A method of synthesizing a linear-reversible-linear (LRL) copolymer, the method comprising:
copolymerizing a sticky monomer and a spacer monomer to form a random copolymer; and
copolymerizing the random copolymer with a small monomer to form the LRL copolymer.

17. The method of claim 16, wherein copolymerizing the sticky monomer and the spacer monomer comprises:
combining 2f-BiB, anisole, the sticky monomer, and the spacer monomer to produce a first random copolymer solution;
combining the sticky monomer and the spacer monomer with a catalyst solution;
introducing a reducing agent to the first random copolymer solution, thereby producing a second random copolymer solution;
reacting the second random copolymer solution, thereby producing a crude random copolymer; and
purifying the crude random copolymer to form the random copolymer.

18. The method of claim 16, wherein copolymerizing the random copolymer with the small monomer comprises:
combining a methacrylate compound, the random copolymer, and anisole;
combining the methacrylate compound and the random copolymer with a catalyst solution, thereby producing a first LRL solution;
reacting the first LRL solution to produce a crude LRL copolymer; and
purifying the crude LRL copolymer, thereby producing the LRL copolymer.

19. The method of claim 16, the method further comprising synthesizing the sticky monomer by:
combining an amino containing compound with an acetate;
combining the amino containing compound and the acetate with acetic anhydride to form a first monomer solution;
introducing an alcohol to the first solution to produce a second monomer solution;
evaporating solvent from the second solution to produce a first acetamido compound;
combining the acetamido compound with acrylic acid and a solvent to produce a third monomer solution;
and evaporating solvent from the third solution to produce a crude sticky monomer; and
purifying the crude sticky monomer to produce the sticky monomer.

20. A method of additive manufacturing, the method comprising: 3-d printing an article using an LRL copolymer as the feedstock.
